(19) United States
(12) Patent Application Publication
(10) Pub. No.: US 2021/0287551 A1
(43) Pub. Date: Sep. 16, 2021

(54) System for synchronizing signals between multiple vehicles

(71) Applicant: Tamar Thomas Monrad Pedersen, New Tripoli, PA (US)

(72) Inventor: Tamar Thomas Monrad Pedersen, New Tripoli, PA (US)

(21) Appl. No.: 16/816,046

(22) Filed: Mar. 11, 2020

(51) Int. Cl. G08G 1/00; B60W 30/16; H04W 4/46

(52) U.S. Cl. CPC G08G 1/22; H04W 4/46; G08G 1/20; B60W 30/16

(57) ABSTRACT

A system and method for synchronizing lighting patterns and/or equipment between multiple vehicles, including a controller that receives signals from other systems on the vehicle, which may include, but are not limited to antenna for in-car satellite receivers, radar detection systems, and wireless communication systems for communicating with other vehicles. Based on these input signals, the control system may initiate communication with other vehicles having the inventive control system, and thereby generate signals to control other vehicles lighting patterns and/or equipment in a synchronized fashion.

### BACKGROUND OF THE INVENTION

The present invention pertains to a control system, which allows for the controlling of vehicle lighting patterns, which may include turn signals and headlights, or other vehicle equipment such as a horn or security system chirp, in such a fashion that these components may be operated in coordination with multiple other vehicles, so that said signals are synchronized.

When automobile enthusiasts encounter other drivers of vehicles similar to their own, it is common for them to acknowledge one another as the vehicles pass each other on the road, with a gesture such as a head nod, or hand wave. What if they had the ability for their cars to participate in this acknowledgement, by automatically flashing blinkers and chirping as the vehicles approached each other? A real car lover might jump at the opportunity to possess a vehicle including such a feature.

You might also imagine a car show, where the emergency flashers on all of the vehicles from a given manufacturer blink in synchronization with each other. The perceived sense of community this could engender in real automobile enthusiasts could be significant. The WOW factor of such a feature might be enough to influence a purchasing decision, enabling the driver to participate in the car lover experience. A vehicle could be purchased from the manufacturer, including such a feature, or a controller could be added to a vehicle as an after-market add on.

Once the vehicle including the inventive system, is on the road, imagine the vehicle sitting at an intersection with it's turn signals on. Other vehicles including the inventive system, which happen to be at the same intersection, with their blinkers on, would blink in synchronization with each other. In fact, all vehicles on the planet, with the inventive system, which had blinkers on at a given moment, would be blinking in synchronization. Informal polling has been conducted, with automobile enthusiasts, and they seem to agree they would enjoy driving a car including such a feature.

It would be up to each automobile manufacturers own marketing departments to gauge the amount of interest and enthusiasm such a feature might generate. Entire marketing campaigns could be built around defining a brand that is community based, with vehicles that help build that sense of belonging, customer loyalty and engagement, through synchronous signaling.

### SUMMARY OF THE INVENTION

According to one aspect of the present invention, a control system is provided to control vehicle components, such as exterior headlights, turn signals, horns, security system chirps, and the like, in such a way, that the operation of these components may be coordinated or synchronized with other vehicles containing the inventive system.

According to another aspect of the present invention, the control system shall cause vehicle lighting patterns, such as turn signals, and emergency flashers to blink in synchronization with a signal generated by a global satellite system, or other master clock, allowing all vehicles containing the inventive system to operate signal patterns in a synchronous fashion.

According to another aspect of the present invention, the control system shall cause vehicle lighting patterns, such as turn signals, and emergency flashers to blink in synchronization with other vehicles communicating with each other over a wireless network.

According to yet another aspect of the invention, the control system may detect another vehicle approaching, causing the driver's own vehicle and approaching vehicle to actuate vehicle components such as exterior headlights, turn signals, horns, security system chirps, and the like, in a synchronized fashion, when the vehicles are within a predetermined distance, D, of each other.

According to another aspect of the invention the driver may optionally engage the capability to acknowledge another vehicle with lighting patterns, turn signals and chirps on demand as initiated by the driver, or in a continuous mode whenever another vehicle with the inventive system is encountered.

### BRIEF DESCRIPTION OF THE DRAWINGS

FIG. 1 is a diagram showing modern vehicle communication components

FIG. 2 is a diagram showing multiple vehicles synchronized with a global satellite clock

FIG. 3 is a diagram showing synchronization of a vehicle blinker clock with a satellite signal clock

FIG. 4 is a diagram showing how One-Shot synchronization may be implemented

FIG. 5 is a flowchart for the Vehicle Scan List Generation algorithm

FIG. 6 is a flowchart for the Blink Sync Generation algorithm

FIG. 7 is a diagram showing Blink Sync Scenario

FIG. 8 is a diagram showing Continuation of Blink Sync Scenario

### DETAILED DESCRIPTION OF THE INVENTION

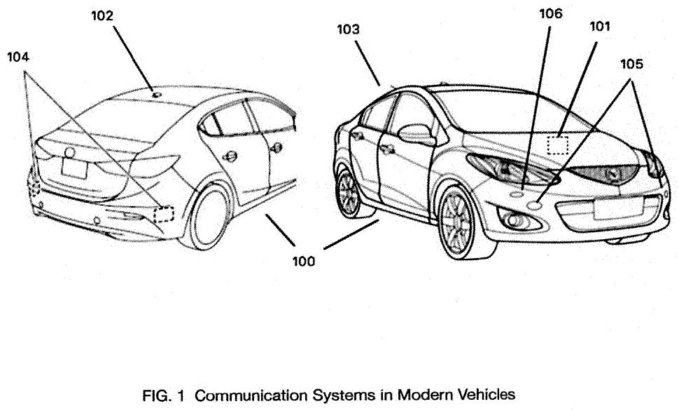

The control system contemplated in the inventive system may send and receive signals from any of a variety of components, that are typically available in most modern vehicles. Such components are illustrated in FIG. 1, and may include, but are not limited to an antenna for an in-car satellite receiver 102, a front 105 and rear 104 radar receiver and transmitter, a wireless access point 103 for communicating with other vehicles, and microwave 106. These components would enable the control system 101 to receive signals from satellite, radar or wireless networks. These wireless networks could include a multiplicity of other vehicles with the inventive system, allowing these vehicles to send and receive wireless messages from each other. In response to signals sent to and received from these components, the control system will be able to control the lighting patterns and/or equipment, allowing multiple vehicles signals to operate in a synchronized fashion.

The intent of the inventive system is not to add any new communication technologies or standards, but simply to utilize existing systems in a new way. Many methods and standards already exist for Vehicle-to-Vehicle (V2V) communication. Wireless connectivity between moving vehicles can be provided by existing 802.11 compliant devices, by setting up a mobile ad-hoc network [1], [2], [3]. A mobile ad-hoc network is a collection of mobile hosts with wireless communication capabilities forming a temporary network. Wireless communications are spontaneously created for data exchange, using short to medium range transmission, omnidirectional broadcast, and by sending low bandwidth messages between moving nodes. Existing studies [4] document the capability to communicate wirelessly, by using technologies such as dedicated short-range communications (DSRC) [5], cellular network technologies [6], [7], [8], Wi-Fi [9], White-Fi [10], infrared (IR) [11], and visible light communications (VLC) [12]. Through using one of these technologies, or their combination, a variety of data generated by vehicles can be shared successfully, to support the features required by the inventive system.

### Satellite Synchronization of Signals

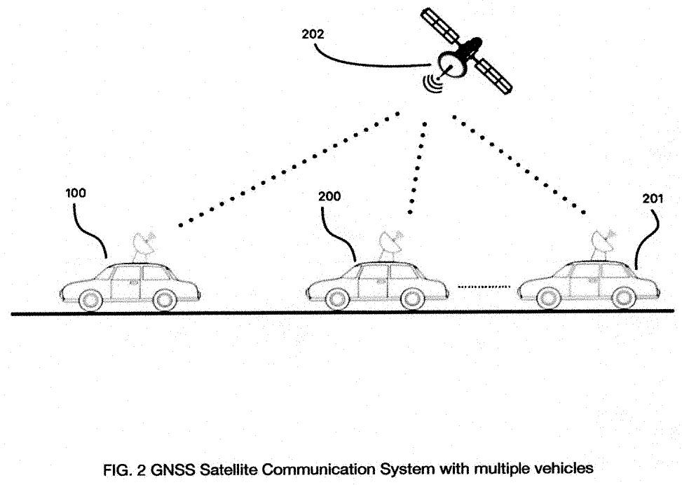

Many modern vehicles are equipped with satellite receivers, which allow for determining precise GPS coordinates, and timing. As is well understood and appreciated by those skilled in the art, signals from Global Navigation Satellite Systems (GNSS) [13] may be received by vehicles equipped with antenna satellite receivers. Signals from a satellite may convey GPS position and location, as well as highly accurate clock signals. This invention contemplates using these signals to control the synchronization of vehicle lighting patterns such as turn signals, and emergency flashers. An example of GNSS communication, between a satellite 202, and multiple vehicles 100, 200 and 201, is illustrated in FIG. 2. The first vehicle 100, receives a signal from the satellite, with which it's blinker signals may be synchronized. The same signal may be simultaneously received by a second vehicle 200, and up to as many as “n” vehicles, where “n” is the number of vehicles that have been manufactured, that include the inventive system, depicted in FIG. 2, as vehicle 201, which is the nth vehicle. Each vehicle has a satellite receiver capable of receiving precise timing and location information.

In order to synchronize the turn signals and emergency flashers of multiple vehicles, the control system will constantly be monitoring the clock signal generated by a global satellite system. The clock from the satellite system will comprise a master clock, which the control system will slave to. One possibility would be for turn signals to be turned on during even seconds, and off during odd seconds, slaving to a wall clock generated by the satellite. Alternatively, a clock could just be a square wave signal, that transitions high and low, with blinkers on while the clock is high, and off while the clock is low. As has been established in the literature, methods exist to compensate for the delay in GNSS clock signals [14] received by a vehicle, from a satellite, so that precise timing is achievable. Using this technology it is not difficult to synchronize clocks to within approximately a millisecond, which would be imperceptible to the human eye.

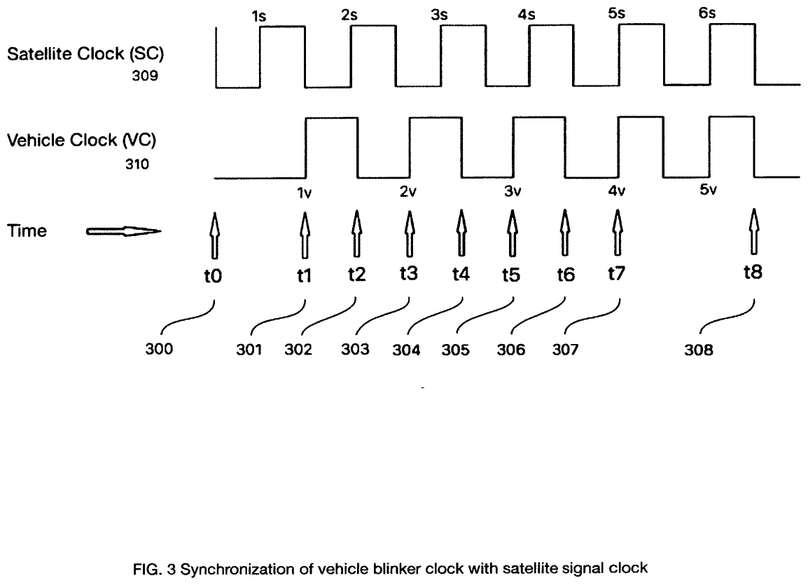

If a turn signal is actuated in an individual vehicle, the control system will synchronize the blinkers with the clock received by the global satellite system clock. All vehicles with the inventive system will do likewise, providing the appearance that blinkers on multiple vehicles are flashing in synchrony. If a driver actuates turn signals or emergency flashers, and the initiation is out of phase with the clock signal, SC, coming from the satellite system, an algorithm running on the control system ensures that the vehicle blinker signal clock, VC, will gradually synchronize with the clock from the satellite, over the first N pulses of the blinker, as shown in FIG. 3. This gradual drift of the turn signal, until it is synchronized with the master centralized clock generated by the satellite system, should be imperceptible to the human eye, as the vehicle slave clock VC gradually syncs up with the satellite master clock SC.

For purposes of illustration, assume the satellite clock period is 2 seconds. If the vehicle blinker is actuated, and the vehicle blinker clock VC is in phase with the satellite clock SC, the blinker will be on for one second, and off for one second, and then repeat, until the blinker is disengaged. When VC is high the blinker is on, and when VC is low the blinker is off. If the blinker signal is initiated, in such a way that it is out of phase with the satellite clock SC, the vehicle clock VC period will be extended by an additional 1/N seconds.

FIG. 3 illustrates what the satellite clock (SC) 309 and the vehicle blinker clock (VC) 310 will look like if the vehicle blinker is initiated 180 degrees out of phase with SC. This will require the maximum amount of time for the signals to sync up with each other. FIG. 3 illustrates how the clock signals would appear if the number of clock pulses, N, over which the satellite clock, and the vehicle clock synchronize, is set equal to 3. Other values for N may be used, but setting N to 3 allows a reasonably small amount of time for the clock signals to synchronize, while also stretching the VC clock period in a such a way that it is almost imperceptible to the human eye.

At time t0 300, the vehicle blinker has not been turned on. Then at time t1 301, the vehicle blinker is actuated by the driver, and SC 309 and VC 310 are 180 degrees out of phase with each other. The first period of SC starts at 1 s, the second at 2 s and so on. The first period of VC 310 starts at 1 v, the second at 2 v, and so on. If SC 309 and VC 310 are out of phase by more than ⅓ of a second, the period of VC 310 is extended by ⅓ of a second. At time t1 301 the difference between the clocks is more than ⅓ of a second. As a result, ⅙ of a second is added to the VC 310 clock before it transitions low at t2 302. An additional ⅙ of a second is added to the VC 310 clock before it transitions high again at t3 303. A complete period of VC 310 is extended by ⅓ of a second, which occurs between t1 301 and t3 303. The difference between the clocks is calculated again at t3 303, and since the difference is still greater than ⅓ of a second, the VC 310 clock is again extended by ⅓ of a second over the next period of the VC 310 clock. This process continues until t7 307, when the difference between the clocks is zero. The VC 310 clock is now in sync with SC 309, so VC 310 will no longer be extended. The clocks are in sync, and will remain so, until the blinker is disengaged. This process required a total of 3½ seconds, between t1 301 and t7 307. At t8 308, the blinker is turned off.

It no global satellite clock signal is detected, the vehicle lighting, signals and other components will default to operating in the customary fashion.

Signal Synchronization with another Vehicle

The driver of a vehicle may optionally direct the control system to operate the vehicle lighting, signals, or other components, in synchronization with one or more other vehicles. In order to achieve this, the vehicle must be equipped with a satellite receiver for GPS coordinates and the ability to communicate with a wireless transmitter and receiver. Many modern vehicles are already equipped with such equipment, as previously illustrated. The control system must be able to send and receive signals from these devices to realize the intent of this invention.

The driver of a vehicle may optionally select the engagement of synchronization of signals, either on demand, in a one-shot fashion, or automatically, in a continuous autonomous fashion. The driver may also optionally disable the control system, so that no signals from other vehicles are acted upon.

### On Demand—One-Shot Synchronization

In the course of driving, the driver of a vehicle, which contains the inventive system, may see another vehicle approaching, and if the approaching vehicle is also equipped with the inventive system, the driver may initiate a blinker synchronization request, hereafter referred to as a “Blink Sync”. When the vehicles are sufficiently close they may then acknowledge each other by flashing signals, or operating other equipment, simultaneously.

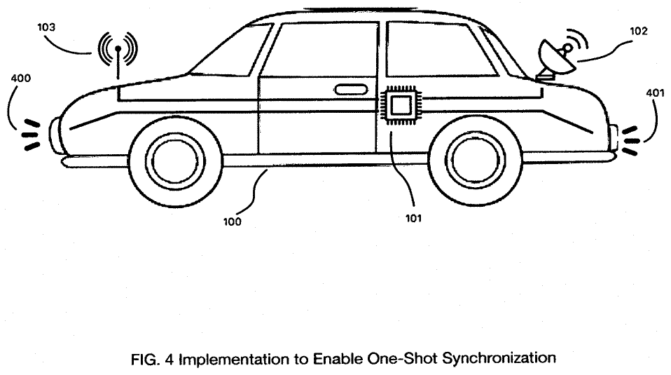

A Blink Sync could be initiated simply by the driver pressing a button, issuing a voice command, or any other method by which the driver signals the control system with a Blink Sync request. One possible implementation of how this could be achieved is demonstrated in FIG. 4. If a Blink Sync request is received, the control system 101, on vehicle 100 starts scanning for other vehicles containing the control systems, that are found to be wirelessly in range, using the wireless access point 103. The wireless access point is capable of transmitting and receiving wireless messages. Assume a second vehicle, denoted 100′, is approaching. This vehicle contains the same components depicted in FIG. 4, with a wireless access point 103′, satellite receiver 102′, front signals 400′ and rear signals 401′. The wireless access point 103, on vehicle 100 receives a broadcast message from vehicle 100′, and conveys the message to the control system 101. The GPS coordinates of both vehicles, 100 and 100′, are determined as the GPS coordinates are received by 102 and 102′. These coordinates are used to determine the distance between the two vehicles. If the distance between the vehicles is less than a configurable distance, D, the control systems 101 and 101′, on both vehicles 100 and 100′, complete the Blink Sync request by wirelessly sending a Blink Sync acknowledgement to each other. When each vehicle's control system 101 and 101′ receive the Blink Sync acknowledgement they both send a predefined signal to their respective vehicles that causes the vehicle lighting and turn signals 400, 400′, 401, 401′, and/or other components on both vehicles to respond with an Blink Sync acknowledgement event. The Blink Sync acknowledgement event can be any predefined response visible and/or audible to the drivers in each vehicle. For example, the headlights, and turn signals could flash, together with a chirp of the security system, or any other predetermined set of signals. Once the Blink Sync has been acknowledged, the Blink Sync request has been satisfied, and is cleared. The driver of the vehicle may initiate a new Blink Sync request at will.

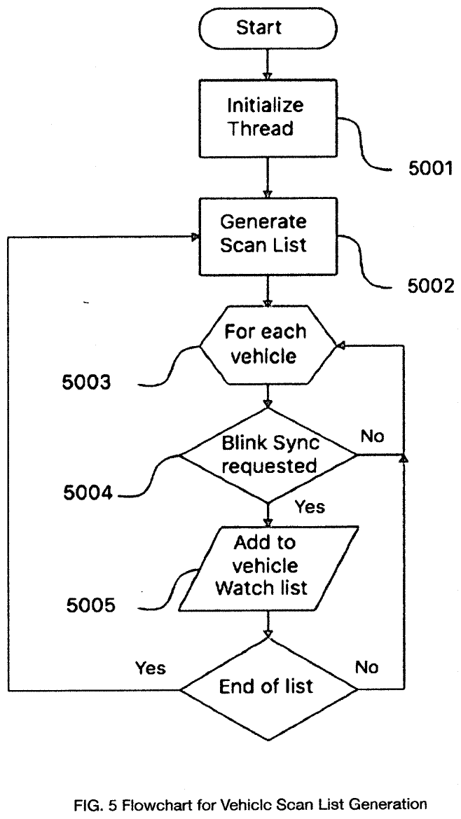

Each control system runs algorithms that implement the above mentioned process. There are at least two asynchronous threads, running in parallel, in the control systems micro controller to achieve the Blink Sync request and acknowledgement. The first thread, Thread1, is illustrated in FIG. 5. Thread1 builds a scan list of vehicles that are wirelessly in range, which have requested a Blink Sync. The control system, in each vehicle, containing the inventive system, constantly wirelessly broadcasts a message, B1, containing the GPS coordinates of the vehicle, and a boolean indicating if the vehicle driver has requested a Blink Sync. Thread1 starts execution, and is initialized in step 5001. In step 5002, the control system builds a scan list of all vehicles from which it has received a wirelessly transmitted B1 message. Step 5003 begins an iterative loop, in which each B1 message received from another vehicle's control system is inspected, to see if a Blink Sync has been requested, as occurs in step 5004. If a Blink Sync has been requested, in step 5005 the vehicle is added to a watch list, together with the GPS location of the vehicle. This vehicle watch list will be passed to the second thread, Thread2. When the end of the list is reached, the loop returns to step 5002, where the scan will be repeated.

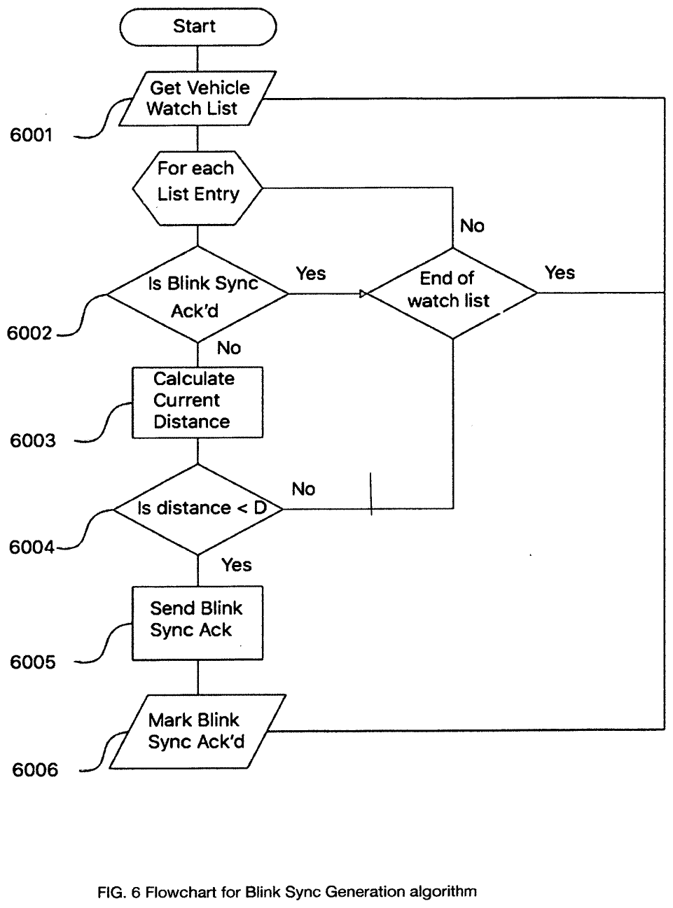

The second thread, Thread2, is illustrated in FIG. 6. Thread2 inspects all of the vehicles in the watch list generated in step 5005, of Thread1, to determine if a Blink Sync acknowledgement should be sent. The first step 6001 of this process acquires the vehicle watch list generated by Thread1. This list comprises a shared resource, which must be semaphore protected. As was documented in Thread 1, only vehicles with control systems that have requested a Blink Sync, will be in this list. Thread2 maintains a table of vehicles that are being monitored, together with state information for each monitored vehicle, i.e. vehicle 200 for the purposes of demonstration, including the current GPS location for the monitored vehicle, as obtained from the B1 message in Thread1, and a boolean indicating if vehicle 100 has already sent a Blink Sync acknowledgement to vehicle 200. Thread2 then iterates over the entries in this list, and for each entry in the list will perform a set of operations, beginning with step 6002, where a check is performed to see if Thread2 has already acknowledged the Blink Sync request. If so, this entry may be ignored, and the loop continues with the next entry. If there are no more entries in the watch list, Thread2 returns to step 6001. If the Blink Sync has not been acknowledged then Thread2 proceeds with step 6003, where the distance D between vehicle 100 and the monitored vehicle 200, will be calculated, using the current GPS location of vehicle 100 and the GPS location of vehicle 200, as captured in Thread1. In step 6004, a check is performed to see if the calculated distance between vehicle 100 and 200 is less than a predetermined distance D. The value of D shall be selected in such a way that the visual/aural effect for drivers in vehicle 100 and 200 is optimized, i.e. when the vehicles are within 100 ft of each other. If the distance is not less than D, then the vehicles are not yet close enough to perform a Blink Sync operation, and Thread2 moves on to the next watch list entry. If the distance is less than D, then in step 6005 a Blink Sync acknowledgement is wirelessly transmitted by the control system to vehicle 200. In step 6006 vehicle 100 marks vehicle 200 as having been sent a Blink Sync acknowledgement, and Thread 2 returns to the top of Thread2, at step 6001.

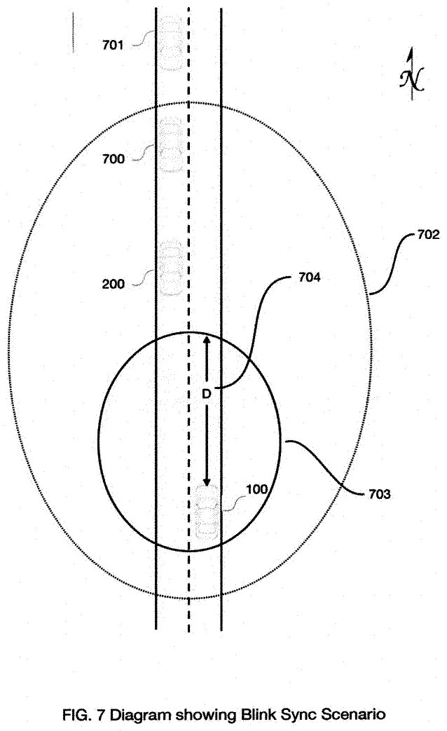

In FIG. 7, a scenario is depicted that illustrates how a Blink Sync interaction between two drivers may occur. In this scenario, the driver of vehicle 100 is traveling North bound, when they observe vehicle 200 traveling towards them, in the South bound direction.

The driver of vehicle 100 indicates to the control system, through a button push on the vehicle dashboard, a voice command, or other alternate method that they would like to initiate a Blink Sync, with the approaching vehicle 200. The control system 101 on vehicle 100 starts executing Thread1. In FIG. 7, the dotted line that encircles Region B 702 shows the area that is wirelessly within range of vehicle 100. Both vehicle 200 and 700 are within range, and are scanned by Thread1 to determine if they are also requesting a Blink Sync. Vehicle 701 is not yet within range of the wireless network, and it is not scanned, at this point in time. Since only vehicle 200 has requested a Blink Sync, the watch list on vehicle 100 only contains one entry-vehicle 200. Thread1 on vehicle 200 is simultaneously performing the same scan, and discovers vehicle 100 has requested a Blink Sync. The watch list on vehicle 200 only contains one entry—vehicle 100.

At this point, Thread2 on vehicle 100 acquires the watch list containing vehicle 200, and on vehicle 200 acquires the watch list containing vehicle 100. Since neither vehicle has acknowledged the Blink Sync request yet, Thread2 on both vehicles continues by calculating the distance D 704 between the vehicles. Region A 703, in FIG. 7, shows the distance D 704 that a vehicle must fall within, in order for vehicle 100 to respond with a Blink Sync acknowledgement. Since vehicle 200 is not yet within Region A 703, no Blink Sync acknowledgment is sent, and Thread2 returns to the beginning.

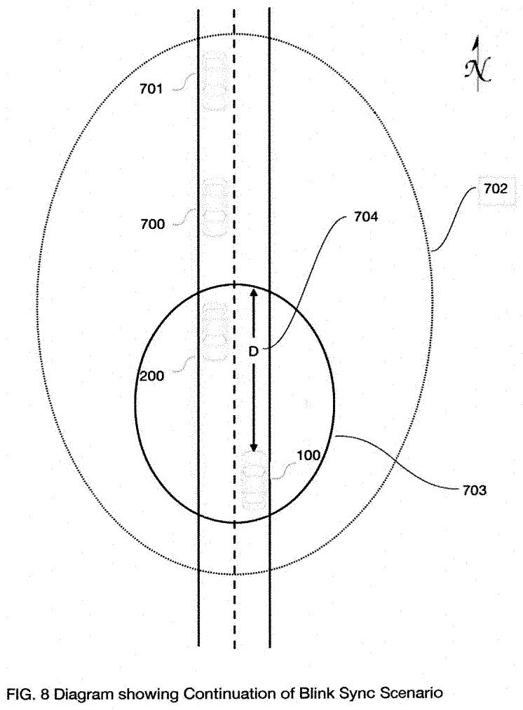

When the next iteration of Thread1 and Thread2 begins executing on Vehicle 100 and 200, the distance between the vehicles has closed, as depicted in FIG. 8. From the perspective of vehicle 100, vehicles 200, 700 and 701 are wirelessly in range, but only vehicle 200 has requested a Blink Sync, and is found to be in the watch list, by the control system on vehicle 100. In Thread2, vehicle 200 is found to be within Region A 703, so the distance between vehicle 100 and vehicle 200 is calculated to be less than distance D 704. As a result, a Blink Sync acknowledgement is wirelessly sent to vehicle 200, and vehicle 200 is marked by the control system 101 on vehicle 100 as having been acknowledged. This state persists until the driver of vehicle 100 requests a new Blink Sync acknowledgement, and thus prevents vehicle 200 from being acknowledged more than once. The control system on vehicle 200 simultaneously sends a blink Sync acknowledgement wirelessly back to vehicle 100.

The control system shall be configurable, in such a way that it will only respond to a uniquely identifiable set of vehicles. For instance, the control system could have the ability to determine the make and model of the vehicle's manufacturer, in which it is installed. The driver of the vehicle could specify that the control system should only initiate a blinker synchronization request if the make and model of an approaching vehicle is an exact match. The driver could also specify that the control system may initiate a blinker synchronization request to any vehicle from the same manufacturer, regardless of the model of the vehicle. Finally, the driver could specify that the control system may initiate a blinker synchronization request to any vehicle containing the inventive system, even if the approaching vehicle is from another manufacturer. Based on the configuration of the control system, by the driver, requests from other control systems could also be filtered out, if they do not meet the driver's criteria.

### Autonomous Vehicle Signal Synchronization

The driver of a vehicle, which contains the inventive system, may optionally switch on automatic detection of other vehicles with the inventive system, allowing the control system to continuously monitor for other vehicles automatically. If the distance to any other wirelessly accessible vehicle is found to be closing, when the distance between these vehicles is found to be less than a configurable distance, D, the control system on the vehicle will autonomously issue signals to both vehicles, as discussed in the previous section, resulting in an acknowledgement event.

Measures must be taken to build hysteresis into the system, so that two vehicles traveling next to each other, in the same direction, which are both set to autonomously signal, do not result in constant acknowledgement events.

### REFERENCES

[1] U. Hernandez-Jayo, A. S. K. Mammu, and I. De-la Iglesia, “Reliable communication in cooperative ad hoc networks,” in Contemporary Issues in Wireless Commun. InTech, November 2014.
[2] Wikipedia, the free encyclopedia, “Electronic toll collection,” https://en.wikipedia.org/wiki/Electronic toll collection, accessed Apr. 29, 2017.
[3] S. Zeadally, R. Hunt, Y.-S. Chen, A. Irwin, and A. Hassan, “Vehicular ad hoc networks (VANETS): status, results, and challenges,” Telecommun. Syst., vol. 50, no. 4, pp. 217-241, August 2012.
[4] H. Peng, L. Liang, X. Shen, and G. Li, “Vehicular Communications: A Network Layer Perspective” https://arxiv.org/pdf/1707.09972.pdf
[5] S. Biswas, R. Tatchikou, and F. Dion, “Vehicle-to-vehicle wireless communication protocols for enhancing highway traffic safety,” IEEE Commun. mag., vol. 44, no. 1, pp. 74-82, January 2006.
[6] L. Liang, G. Y. Li, and W. Xu, “Resource allocation for D2D-Enabled vehicular communications,” IEEE Trans. Commun., vol. 65, no. 7, July 2017.
[7] K. Abboud, H. A. Omar, and W. Zhuang, “Interworking of DSRC and cellular network technologies for V2X communications: A survey,” IEEE Trans. Veh. Technol., vol. 65, pp. 9457-9470, December 2016.
[8] S. Chen, J. Hu, Y. Shi, and L. Zhao, “LTE-V:ATD-LTE-Based V2X solution for future vehicular network,” IEEEInternet Things J., vol. 3, no. 6, pp. 997-1005, December 2016.
[9] N. Lu, N. Cheng, N. Zhang, X. S. Shen, J. W. Mark, and F. Bai, “Wi-Fi hot spot at signalized intersection: Cost-effectiveness for vehicular internet access,” IEEE Trans. Veh. Technol., vol. 65, no. 5, pp. 3506-3518, May 2016.
[10] H. Zhou, N. Cheng, Q. Yu, X. S. Shen, D. Shan, and F. Bai, “Toward multi-radio vehicular data piping for dynamic DSRC/TVWS spectrum sharing,” IEEE J. Sel. Areas Commun., vol. 34, no. 10, pp. 2575-2588, October 2016.
[11] P. Fernandes and U. Nunes, “Platooning with DSRC-based IVC-enabled autonomous vehicles: Adding infrared communications for IVC reliability improvement,” in Proc. IEEE IV, Alcala de Henares, Spain, 2012, pp. 517-522.
[12] P. H. Pathak, X. Feng, P. Hu, and P. Mohapatra, “Visible light communication, networking, and sensing: A survey, potential and challenges,” IEEE Commun. Surv. Tutor., vol. 17, no. 4, pp. 2047-2077, 4th Quarter 2015.
[13] C. J. Hegarty, “GNSS signals—An overview”, IEEE International Freq. Control Symposium Proceedings, July 2012.
[14] P. Banerjee, “Timing in GNSS—its importance and challenges”, 2015 International Conf. on Microwave and Photonics (ICMAP), December 2015.

1. A system, which includes a control system for interacting with vehicle communication systems, such as a wireless access point, a satellite signal receiver, or other communication systems, from which information may be collected, and processed, that allows multiple vehicles to coordinate signals, such as flashers, in a synchronized fashion.

2. A system, which allows the driver of a vehicle to initiate an acknowledgement of another vehicle, with the inventive system, by sending a signal to a control system, which starts scanning for other vehicles, with the inventive system, that have also requested an acknowledgment, and when one is found, and is within a specified range allows the vehicles to reciprocally coordinate signals, such as flashers, in a synchronized fashion.
